(19) United States
(12) Patent Application Publication
(10) Pub. No.: US 2024/0091777 A1
(43) Pub. Date: Mar. 21, 2024

(54) Histological Apparatuses for Histological Samples with Humidity Control Lid and Thermal Cover Having Intermittent Access

(71) Applicant: Parhelia Biosciences Corporation, Austin, TX (US)

(72) Inventor: Nikolay SAMUSIK, Talent, OR (US)

(73) Assignee: Parhelia Biosciences Corporation, Austin, TX (US)

(21) Appl. No.: 18/468,941

(22) Filed: Sep. 18, 2023

Related U.S. Application Data
(60) Provisional application No. 63/376,177, filed on Sep. 19, 2022.

(51) Int. Cl. B01L 3/00

(52) U.S. Cl. CPC B01L 3/5085; B01L 2300/10; B01L 2300/1883

(57) ABSTRACT

A histological container for histological samples is provided with a removable humidity control lid with portals for access into the container. The lid creates a humidified zone across the lid portals to allow processing steps inside the container while minimizing variations in the container humidity. A cover can be placed over the container for thermal control inside the container. The cover includes a top with portals aligned with the lid portals for access through the cover and top to inside the container. The cover can include a shutter slidably interfaced with the top. The shutter can include shutter portals selectively aligned with the top portals. Slidable alignment of the shutter portals with the top portals allows access to inside the container. Slidable nonalignment of the shutter portals with the top portals restricts access, essentially closing the container to control temperature levels and other ambient conditions inside the container.

### CROSS REFERENCE TO RELATED APPLICATIONS

This application claims the benefit of U.S. Provisional Application Ser. No. 63/376,177, entitled “Histological Apparatuses for Histological Samples with Humidity Control Lid and Thermal Cover Having Intermittent Access”, filed Sep. 19, 2022, which is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to histological apparatuses and methods. More specifically, the disclosure relates to histological apparatuses, components, and methods of use for processing histological samples, including staining tissues with reagents.

### Description of the Related Art

Histology refers to the microscopic structure of the tissues of living organisms. To study such structure, histological samples, such as tissues, are often excised from an organism, and examined with microscopes. To assist in the examination, reagents can be used to selectively react chemically with different structures in the histological sample to form a contrast between histological features, such as cells compared to surrounding cells. Multiple selected reagents for multiple cells can form a type of mosaic under the microscope to enable more accurate identification through the contrasts that are created.

Traditionally, histological treatment has been manually performed. The placement of the reagent, spread across the surface of the sample by the reagent, time for the reagent to react and timing of rinsing, and other variables in the preparation of the sample affect the quality and success of a suitable sample for examination. Thus, automatic systems and in some cases including robotic systems have been seen as a solution to control repetitive procedures for the sample preparation. Such systems can also be used for managing multiple samples in small spaces. Such automation has led to standards on sizes of platforms and other features to promote interchangeability between manufacturers. However, within those standards, variations in design and methods occur. As one example, the containers holding the histological samples are typically at least an open top container to allow the robotic access to the sample for depositing the reagents on the sample. Yet, the open top can affect the quality and uniformity by varying conditions in the ambient surroundings. Some systems provide an enclosed area surrounding the histological samples processing center including the robot, cassettes for reagents, rinse stations, and other processing equipment. Clear panels allow operators to monitoring the preparation process. Such enclosures are large and expensive.

Thus, there remains a need for improvements in histological systems and components for the preparation of histological samples, particularly those systems designed for automatic processing with robotic handling systems.

### BRIEF SUMMARY OF THE INVENTION

The present disclosure provides a histological container for histological samples with a humidity control lid with access through portals and in some embodiments a thermal control cover. The container has a removable lid with a humidity control layer that creates a humidified zone across one or more lid portals formed in the lid. In at least one embodiment, the lid portals can be individually aligned with components in the container supporting the samples, so that relatively small portals can allow access to the components for reagent delivery or other processing steps while minimizing variations in the container ambient conditions covered by the lid. The humidified zone can assist in providing a humidity level inside the container that may differ from a humidity level outside the container. A thermal control cover can be placed over at least a portion of the container for thermal control inside the container. The cover can include a top with top portals that are aligned with the lid portals for the access to the container below the lid. The cover can further include a shutter that slidably interfaces with the cover top. The shutter can include one or more shutter portals that are selectively aligned with the cover top portals that are aligned with the lid portals. When the shutter portals are aligned with the top portals, the access to the container below the lid is permitted. When the shutter portals are not aligned with the top portals, access below the lid is restricted, thus maintaining a temperature level inside the container that may differ from a temperature level outside the container. In another embodiment, the cover top can be robotically removed to access the lid and lid portals that can be individually aligned with components in the container supporting the samples.

The disclosure provides a histological system for preparing histological samples, comprising: a container configured to support histological samples for at least applying reagents to the histological samples and having an at least partially open top; and a humidity control lid configured to be coupled with the container and having at least one lid portal configured to be accessed through to an inside of the container, and comprising a humidifying layer having at least one humidifying portal aligned with the lid portal, the humidifying layer configured to create a humidifying zone in the humidifying portal having a humidity greater than the lid portal without the humidifying layer.

The disclosure also provides a histological system for preparing histological samples, comprising: a container configured to support histological samples for at least applying reagents to the histological samples and having an at least partially open top; a lid configured to be coupled with the container and having at least one lid portal configured to be accessed through to an inside of the container; and a thermal control cover configured to be placed at least partially around the container with the lid, the thermal control cover comprising: a top having at least one top portal, the top portal being aligned with the lid portal; and a shutter movably coupled to the top and having at least one shutter portal, wherein the shutter portal is configured to selectively align with the top portal by movement of the shutter relative to the top for selectively access through the shutter portal and top portal and through the lid portal into the container.

The disclosure further provides a histological system for preparing histological samples, comprising: a container configured to support histological samples for at least applying reagents to the histological samples and having an at least partially open top; a humidity control lid configured to be coupled with the container and having at least one lid portal configured to be accessed through to an inside of the container, and comprising a humidifying layer having at least one humidifying portal aligned with the lid portal, the humidifying layer configured to create a humidifying zone in the humidifying portal having a humidity greater than the lid portal without the humidifying layer; and a thermal control cover with a removable top and configured to be placed at least partially over the container with the humidity control lid, the top covering the at least one lid portal of the lid, the lid being configured to be removable by a robot.

### BRIEF DESCRIPTION OF THE SEVERAL VIEWS OF THE DRAWINGS

FIG. 1 is a schematic perspective view of an example of a container used in a system for histological reactions on histological samples.

FIG. 2 is a schematic perspective view of another example of a container used in a system for histological reactions on histological samples.

FIG. 3 is a schematic top left perspective view of an example of a humidity control lid showing lid portals and a humidifying layer for access into the examples of containers of FIGS. 1 and 2.

FIG. 4 is a schematic bottom left perspective view of the humidity control lid of FIG. 3 with the humidifying layer showing humidifying layer portals for access into the container.

FIG. 5 is a schematic cross sectional view of the humidity control lid of FIG. 3 showing a humidified zone.

FIG. 6 is a schematic perspective assembly view of the container with the humidity control lid, illustrating an inside of the container.

FIG. 7 is a schematic view of an illustrative system including a robot, dispenser supply, fluid supply, container with lid, and disposal container with the robot coupling to a dispenser.

FIG. 8 is a schematic view of the system of FIG. 7 with the robot accessing an inside of the container with the dispenser through a lid portal.

FIG. 9 is a schematic view of the container with the lid and an illustrative embodiment of a thermal control cover.

FIG. 10 is a schematic view of the container with the lid and the thermal control cover ready for installation over the container.

FIG. 11 is a schematic view of an illustrative system with a dispenser supply, container with the thermal control cover, and sensor for measuring one or more parameters inside the container.

FIG. 12 is a schematic top left hand perspective assembly view of a cross section of the thermal control cover with a shutter.

FIG. 13 is a schematic top left hand perspective view of a cross section of the thermal control cover with the shutter of FIG. 12.

FIG. 14 is a schematic top left hand perspective view of a cross section of the thermal control cover installed on the container with the lid.

FIG. 15 is a schematic view of an illustrative system including a robot, dispenser supply, fluid supply, thermal cover with the shutter installed over the container with the lid, and disposal container with the robot coupled to a dispenser, with the robot causing the dispenser to slide the shutter into an open position.

FIG. 16 is a schematic view of the system of FIG. 15 with the robot accessing a fluid supply with another dispenser.

FIG. 17 is a schematic view of the system of FIG. 15 with the robot accessing the inside of the container with the dispenser of FIG. 16 through a shutter portal aligned with a cover portal aligned with a lid portal.

FIG. 18 is a schematic view of another the system of FIG. 15 with the robot having another dispenser to cause the shutter to slide into a closed position.

FIG. 19 is a schematic view of another embodiment of the system for histological reactions on histological samples with a thermal cover having a closed top and a waste holding tank.

FIG. 20 is a schematic perspective cross sectional view of the system of FIG. 19 illustrating an exemplary arrangement of components with the container for the histological reactions.

FIG. 21 is a schematic side cross sectional view of the system of FIG. 20.

FIG. 22 is a schematic illustration of a robot portion removably coupled to the top of the thermal cover of FIG. 19 to access the lid having lid portals for the histological reactions.

FIG. 23 is a schematic perspective cross sectional view of the system of FIG. 20 with the top removed to allow access to the lid and lid portals for the histological reactions.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally. The device or system may be used in a number of directions and orientations. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a controller would encompass a processor and a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein.

The present disclosure provides a histological container for histological samples with a humidity control lid with access through portals and in some embodiments a thermal control cover. The container has a removable lid with a humidity control layer that creates a humidified zone across one or more lid portals formed in the lid. In at least one embodiment, the lid portals can be individually aligned with components in the container supporting the samples, so that relatively small portals can allow access to the components for reagent delivery or other processing steps while minimizing variations in the container ambient conditions covered by the lid. The humidified zone can assist in providing a humidity level inside the container that may differ from a humidity level outside the container. A thermal control cover can be placed over at least a portion of the container for thermal control inside the container. The cover can include a top with top portals that are aligned with the lid portals for the access to the container below the lid. The cover can further include a shutter that slidably interfaces with the cover top. The shutter can include one or more shutter portals that are selectively aligned with the cover top portals that are aligned with the lid portals. When the shutter portals are aligned with the top portals, the access to the container below the lid is permitted. When the shutter portals are not aligned with the top portals, access below the lid is restricted, thus maintaining a temperature level inside the container that may differ from a temperature level outside the container.

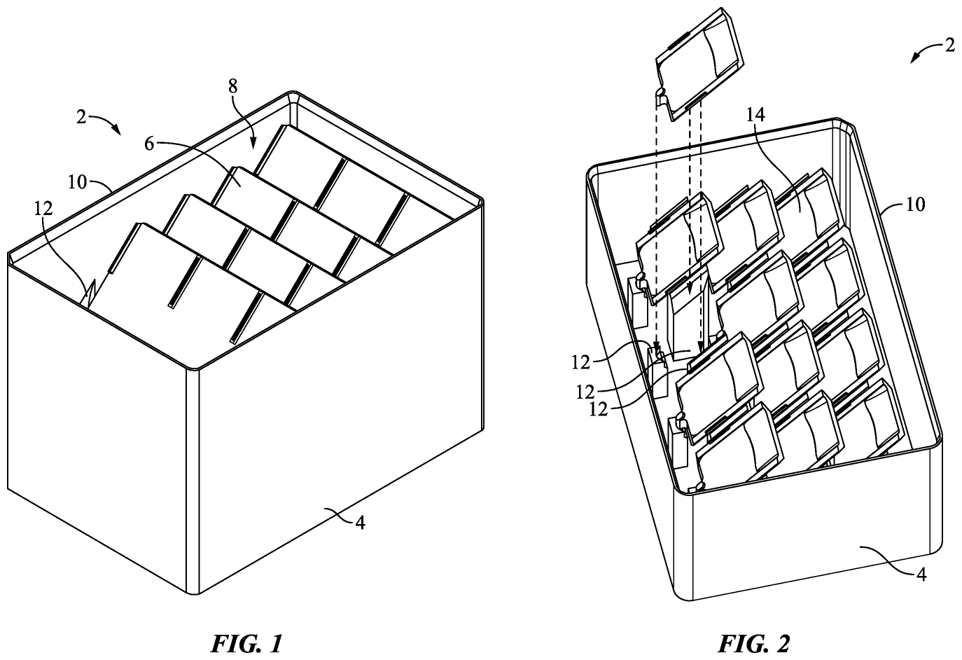

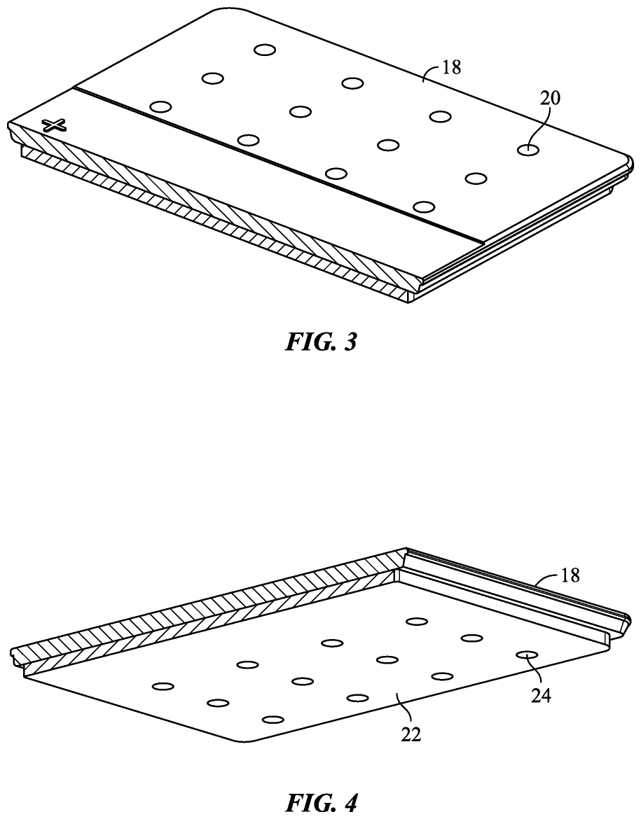

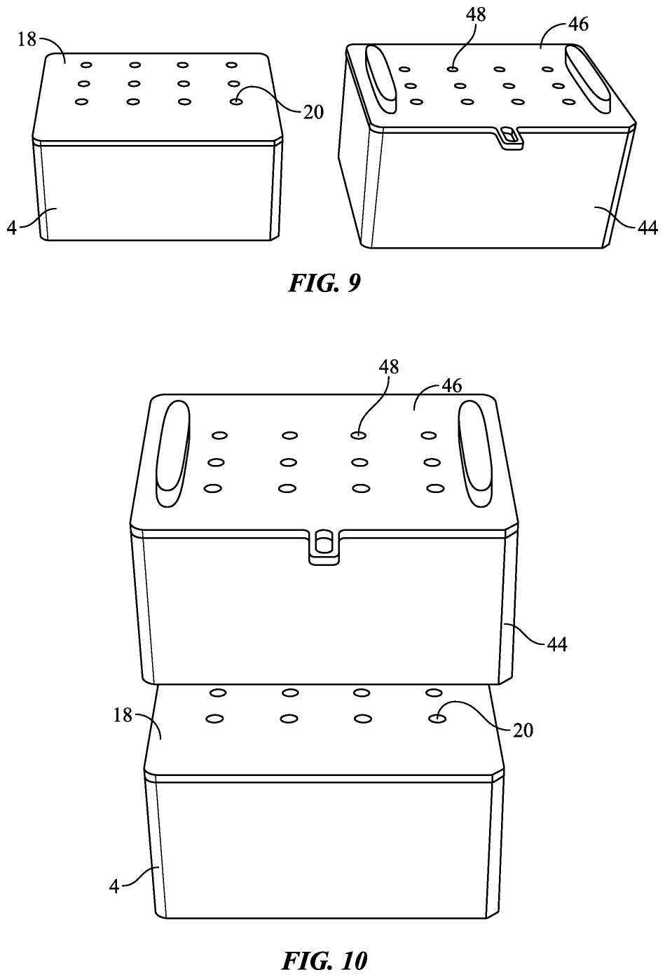

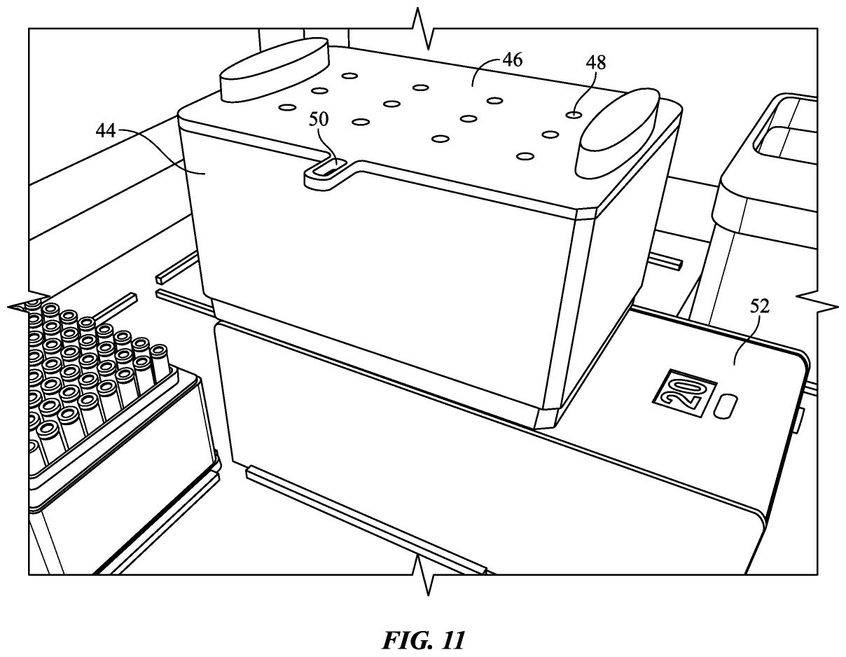

FIG. 1 is a schematic perspective view of an example of a container used in a system for histological reactions on histological samples. The system 2 includes a container 4 with a perimeter 10 and generally at least a partially open top 8 when a lid is not installed that is sufficient to allow access for handling histological samples and their placement. In some embodiments, the system 2 can further include a humidity control lid, shown for example in FIGS. 3 and 4 and described below. In some embodiments, the container can further include a thermal control cover, shown for example in FIGS. 9 and 10 and described below. The container 4 can contain one or more shelves 6 configured to support histological samples.

FIG. 2 is a schematic perspective view of another system for histological reactions on histological samples. Similarly, the system 2 includes a container 4 with a perimeter 10 and generally at least a partially open top 8 when a lid is not installed that is sufficient to allow access for handling histological samples and their placement, and can include the humidity control lid and the thermal control cover. The container 4 can contain one or more container supports 12 for support tiles 14 that are configured to support histological samples.

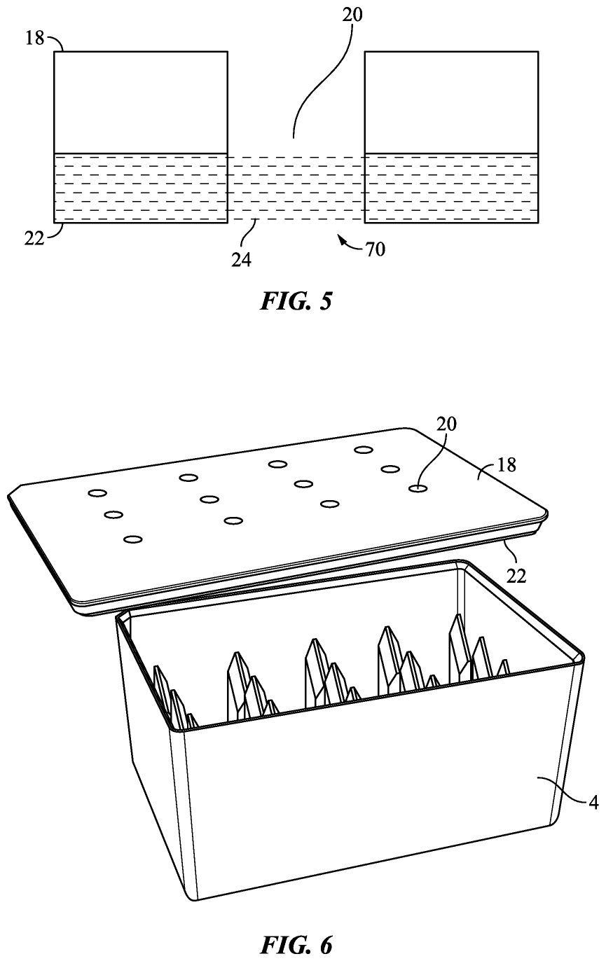

FIG. 3 is a schematic top left perspective view of an example of a humidity control lid showing lid portals and a humidifying layer for access into examples of containers of FIGS. 1 and 2. FIG. 4 is a schematic bottom left perspective view of the humidity control lid of FIG. 3 with the humidifying layer showing humidifying layer portals for access into the container. FIG. 5 is a schematic cross sectional view of the humidity control lid of FIG. 3 showing a humidified zone. The system can include a humidity control lid 18 having one or more lid portals 20 for accessing an inside of the container 4, such as shown in FIGS. 1 and 2. An array of lid portals 20 can be aligned with a corresponding array of components in the container that support the samples. The alignment can facilitate dispensing reagents, rinse fluids, and other chemicals inside the container for processing the samples in the container. The lid 18 can include a humidifying layer 22 having one or more humidifying portals 24. The humidifying portals 24 can be aligned with the lid portals 20 to allow access through the lid 18 to inside the container 4 as described.

In operation, the humidifying layer 22 can be wetted with an appropriate fluid, such as by spraying or dosing the layer with the fluid, generally prior to installation on the container. The wetted layer through evaporation can cause a humidified zone 70, in FIG. 5, across the opening of the humidifying portals 24. Humidity inside the container 4 can be restrained from diffusing through the humidifying portals 24 and corresponding lid portals 18 with a higher density of fluid molecules from the humidity in the humidified zone 70 of the humidifying portals 24. Likewise, humidity outside the container can be restrained from diffusing into the container for the same reason.

FIG. 6 is a schematic perspective assembly view of the container with the humidity control lid, illustrating an inside of the container. The lid 18 can be placed on the at least partially open top 8, so that the container 4 can be at least partially closed during processing. The lid portals 20 and humidifying portals of FIG. 4 can be aligned with appropriate components inside the container 4 to align a dispensing of fluids onto or into the components.

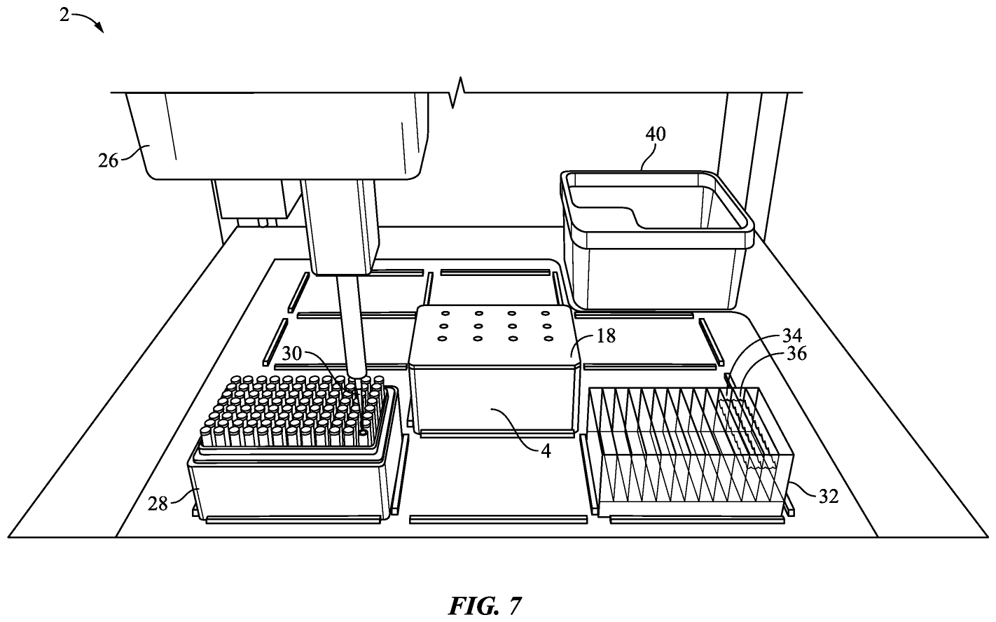

FIG. 7 is a schematic view of an illustrative system including a robot, dispenser supply, fluid supply, container with lid, and disposal container with the robot coupling to a dispenser. The system 2, for example, can include a robot 26 that can be programmed to perform operations needed for the sample preparations. In at least one embodiment, the robot 26 can operate in at least one orthogonal axis and advantageously three orthogonal axes for X-Y-Z movement, or as viewed from FIG. 7, left and right, forward and back, and up and down movements. An inexpensive 3D printer can be a configured to operate in such a manner with at least one axis movement capability and advantageously three axes movement capability. The system 2 can include a dispenser supply 28 arranged with a plurality of dispensers 30, a fluid supply 32 with one or more chemical reservoirs 34, such as for reagents, rinse reservoir 36, the sample container 4, described above, and a waste container 40. The dispenser 30 can be eyedropper-type dispenser, such as a pipette.

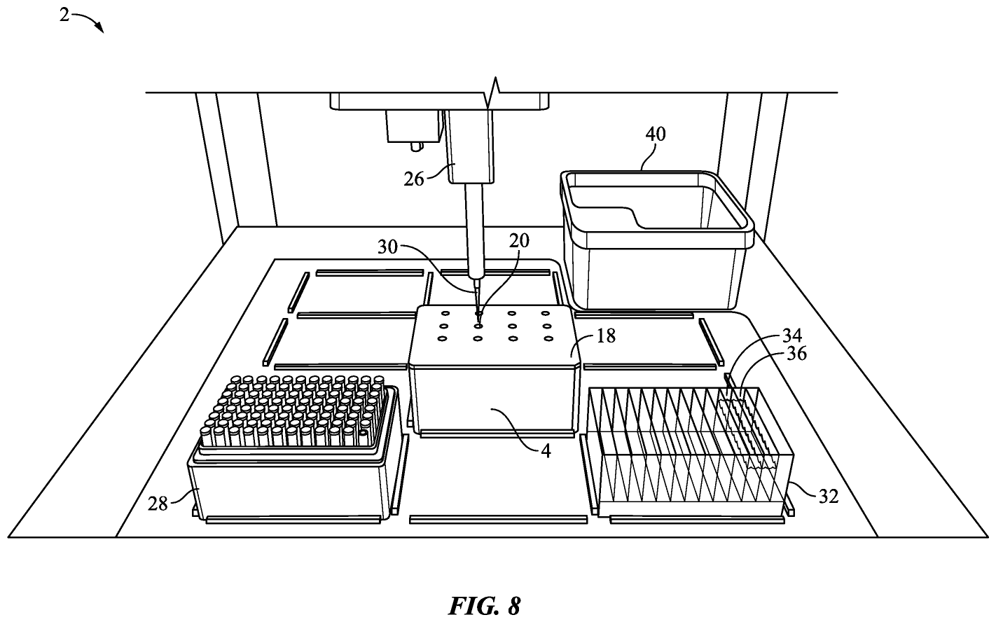

FIG. 8 is a schematic view of the system of FIG. 7 with the robot accessing an inside of the container with the dispenser through a lid portal. In at least one embodiment, the robot 26 can be programmed to couple a dispenser 30 onto the robot, move the dispenser to the fluid supply 32, and obtain fluid from the chemical reservoir 34 or rinse reservoir 36, and move the dispenser with a quantity of the fluid to the container 4 with the lid 18. The robot can align the dispenser 30 with a lid portal 20 on the container 4 and insert the dispenser through the portal into the container volume for dispensing the fluid. When dispensed, the robot 26 can retract the dispenser 30 from the lid portal 20, and move to the waste container 4, and decouple the dispenser from the robot to discard into the waste container.

FIG. 9 is a schematic view of the container with the lid and an illustrative embodiment of a thermal control cover. FIG. 10 is a schematic view of the container with the lid and the thermal control cover ready for installation over the container. FIG. 11 is a schematic view of an illustrative system with a dispenser supply, container with the thermal control cover, and sensor for measuring one or more parameters inside the container. In some embodiments, the system 2 can include a thermal control cover 44 that can be placed over the container 4 having the lid 18. The thermal control cover 44 can include a movable shutter 46 with shutter portals 48. The thermal control cover 44 can be placed over the container 4. The shutter 46 can be moved to selectively align shutter portals 48 with portals below the shutter, including the lid portals and humidifying portals described above. When the several levels of portals are aligned, the dispenser 30 described above can enter through the portals into the container for dispensing (or other process steps as required), as described in more detail herein.

The shutter 46 includes a receiver 50. To move the shutter 46, the receiver 50 can be engaged, such as by the robot 26 that is coupled with a dispenser, to slide the receiver across a top into and out of alignment with underlying portals described in more detail below. The thermal control cover 44 can restrict heat or cold from entering and exiting the container 4 inside the thermal control cover 44, while allowing intermittent access inside the container through the portals in the top of the cover when aligned with shutter portals 48.

A sensor system 52 with an output display can include at least one sensor in or on the container 4 under the cover 46, and can include one or more sensors external to the cover for ambient conditions. The sensor can provide humidity or temperature or both inside the container for optimization of the sample processing.

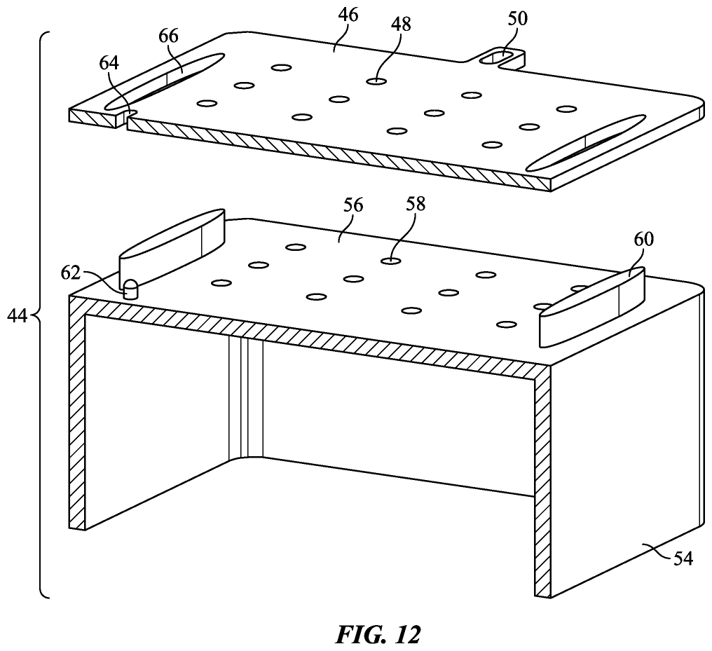

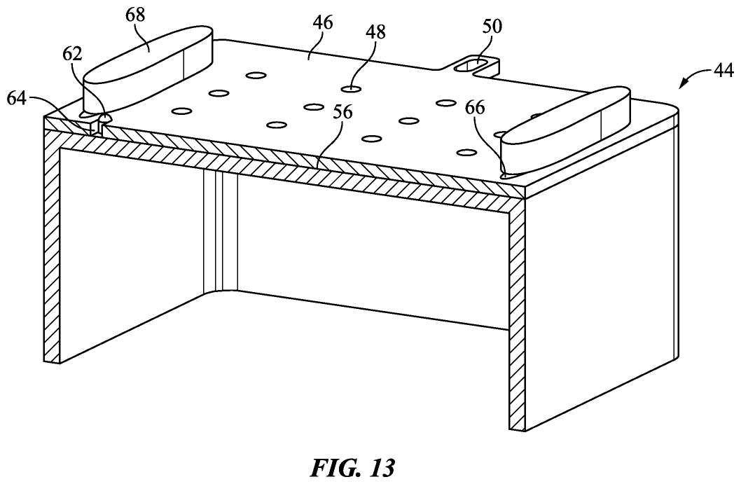

FIG. 12 is a schematic top left hand perspective assembly view of a cross section of the thermal control cover with a shutter. FIG. 13 is a schematic top left hand perspective view of a cross section of the thermal control cover with the shutter of FIG. 12. The thermal control cover 44 can include a perimeter of walls 54 coupled to a top 56 with a shutter 46 movably coupled with the top, generally by sliding relative to the top. The top 56 can include one or more top portals 58. The top portals 58 can be arranged in an array and aligned with portals in the lid 18 of the container 4, described above, when the cover 44 is placed over the container.

The top 56 can further include one or more shuttle guides 60 aligned with corresponding shuttle slide openings 66 in the shuttle 46. The shuttle guides 60 help maintain alignment of the shuttle 46 with the top 56 and the corresponding portals. Generally, the shuttle slide openings 66 are longer than the length of the shuttle guides 60 to allow the shuttle 46 to reciprocally move from one position to another position relative to the top 56. Shuttle caps 68 can be coupled to the shuttle guides 60 with the shuttle 46 disposed therebetween with sufficient clearance to allow the movement of the shuttle.

A receiver 50 can protrude from the main surface of the shuttle 46. The receiver 50 can be engaged by an actuator, such as the robot 26 that can include a dispenser 30 coupled to the robot, described above. The robot 26 can engage the receiver 50 and reciprocally move the receiver and therefore the shuttle 46 relative to the top 56 between an aligned first position for alignment of the shutter portals 48 with the top portals 58 for access through the portals, and a non-aligned second position that excludes access.

The top 56 can include a top calibration guide 62. The shuttle 46 can include a mating shuttle calibration guide 64. In at least one embodiment, the top calibration guide 62 can be a pin, and the shuttle calibration guide 64 can be a slot for mating engagement with the pin. The configuration can be reversed and other embodiments are possible. The calibration guides 62 and 64 allow the shuttle 46 to establish a calibration point of reference in at least two orthogonal axes when the calibration guides are tightly pressed against each other to establish appropriate movement of the shutter relative to the top 56.

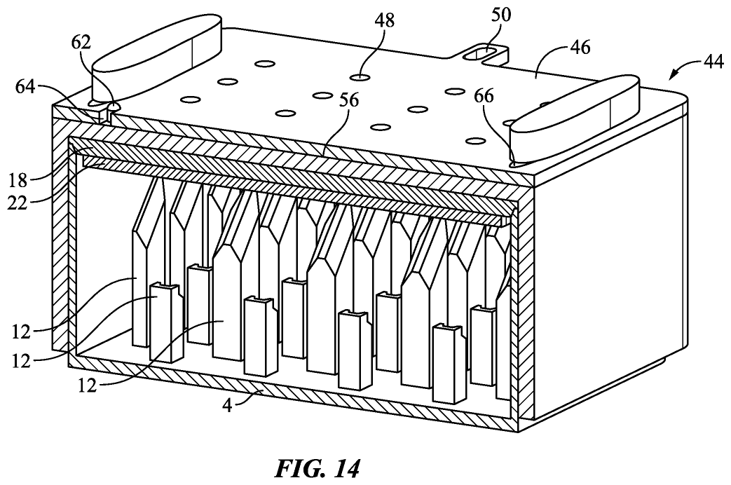

FIG. 14 is a schematic top left hand perspective view of a cross section of the thermal control cover installed on the container with the lid. The assembled combination of the thermal control cover 44 over the container 4 with the humidity control lid 18 provides a relatively inexpensive method for a controlled environment inside the container for the specimens that may be supported in the container. In at least one embodiment, the mutual alignment between the multiple levels of portals provides intermittent access into the container, while allowing controlled conditions when the inside of the container is not being accessed. Specifically, to access the inside of the container 4, the shuttle 46 is positioned so that the shuttle portals 48 are aligned with top portals 58 in the top 56, shown in FIG. 12. Further, the top portals 58 are generally aligned with the lid portals 20 in the lid 18 and the humidifying portals 24 in the humidifying layer 22 coupled with the lid by placement of the thermal control cover 44 over the container 4. To close access to the different layers, the shuttle 46 can be moved to a different position to restrict access from the shuttle 26 into the top 56.

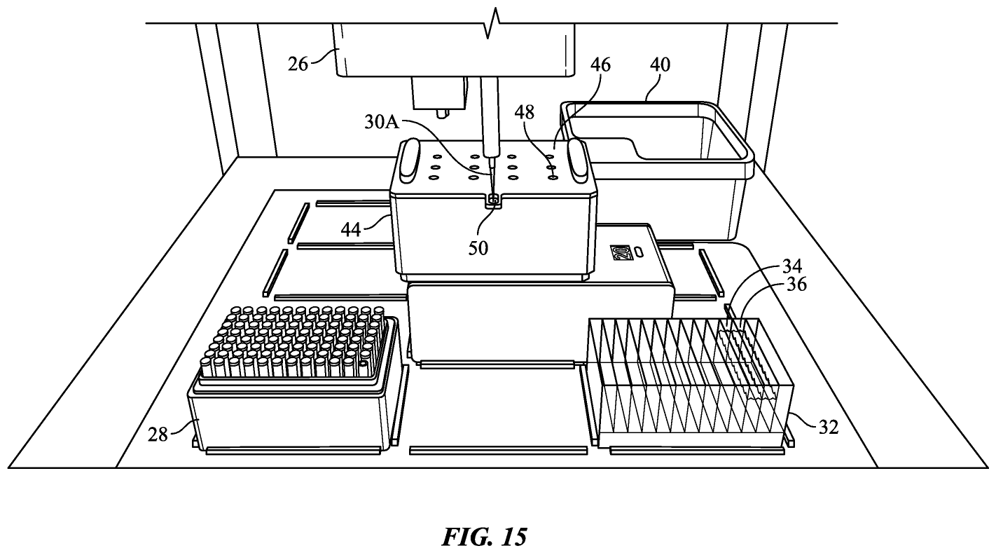

FIG. 15 is a schematic view of an illustrative system including a robot, dispenser supply, fluid supply, thermal cover with the shutter installed over the container with the lid, and disposal container with the robot coupled to a dispenser, with the robot causing the dispenser to slide the shutter into an open position. The illustrative system is similar to the system described in FIG. 7 with the addition of the thermal control cover 44 over the container 4, illustrated in FIG. 7. Thus, the robot 26 shown could further include programming for coupling a dispenser 30A from the dispenser supply 28 and moving to the cover 44 to engage the receiver 50 with the dispenser. In other embodiments, the robot may directly move the receiver without the use of a dispenser. Once engaged, the robot 26 move the shutter 46 such that the shutter portals 48 are aligned with underlying portals of the various layers described above to provide access into the container.

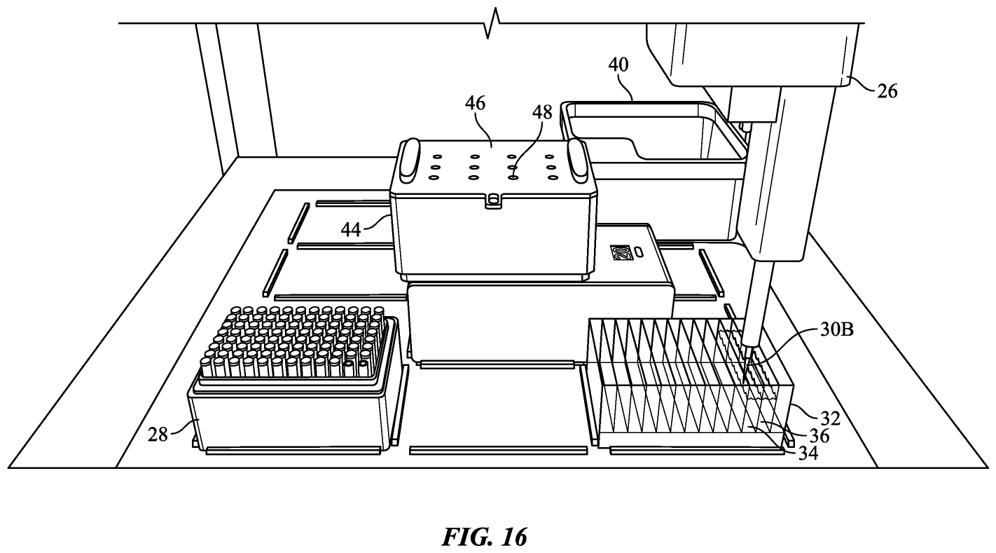

FIG. 16 is a schematic view of the system of FIG. 15 with the robot accessing a fluid supply with another dispenser. The robot 26 can be programmed to retrieve an additional dispenser 30B, after discarding the dispenser 30A in FIG. 15, if used, and move to the fluid supply 32 to obtain fluid from either the chemical reservoir 34 or rinse reservoir 36 into the dispenser for dispensing into the container under the thermal control cover 44 through the shutter 46 with shutter portals 48.

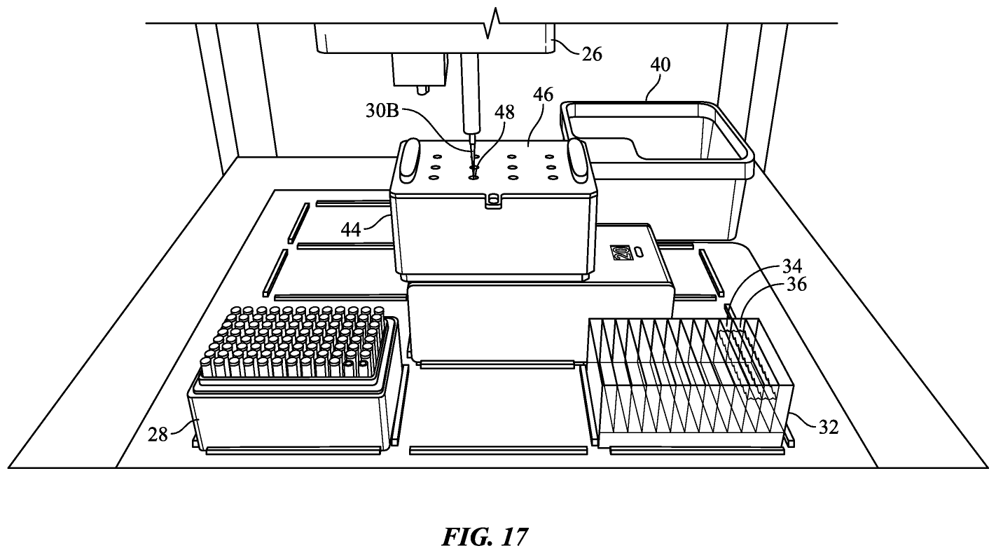

FIG. 17 is a schematic view of the system of FIG. 15 with the robot accessing the inside of the container with the dispenser of FIG. 16 through a shutter portal aligned with a cover portal aligned with a lid portal. The robot 26 can be programmed to move the filled dispenser 30B to the shutter 46. For dispensing the fluid and other processing, the robot can move the dispenser into and through a shutter portal 48 that is aligned with corresponding underlying portals, namely a top portal, lid portal, and humidifying layer portal into the container with the samples. The process can continue with coupling other dispensers with the robot, obtaining fluids required for processing, dispensing fluids through the appropriate shutter portal, discarding the used dispenser, and retrieving another dispenser from the dispenser supply until the process is complete.

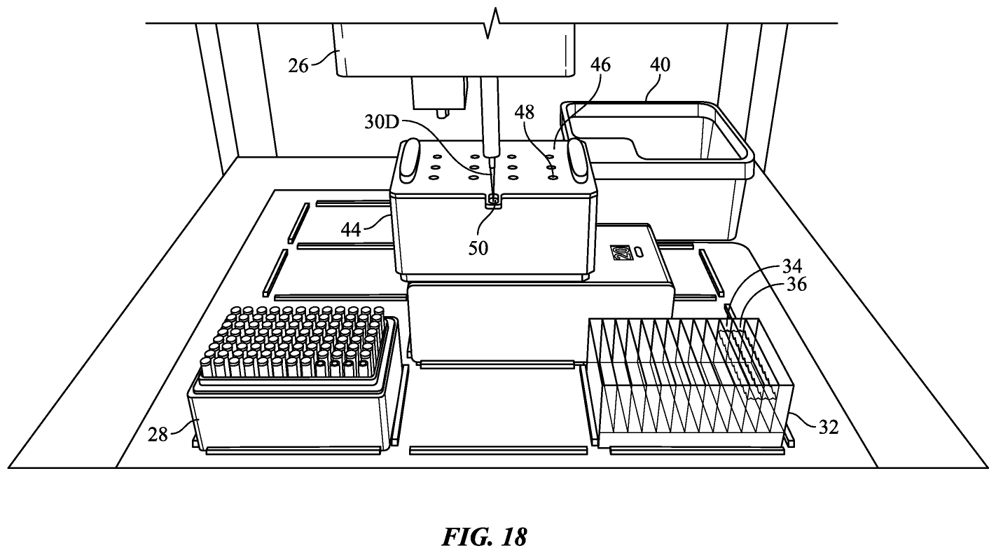

FIG. 18 is a schematic view of the system of FIG. 15 with the robot having another dispenser to cause the shutter to slide into a closed position. When the process is completed for the given time, the shutter portals 48 can be moved out of alignment with the top portals on the thermal control cover 44. The robot 26 can couple another dispenser 30D and move to the receiver 50 on the shutter 46. The robot can engage the receiver 50, such as by inserting the dispenser into the receiver, and moving the shutter in a desired direction to cause nonalignment of the shutter portals 48 with the underlying portals of the top, described above. Thus, the intermittent access to the container 4 can be closed to ambient conditions for process control internal to the container.

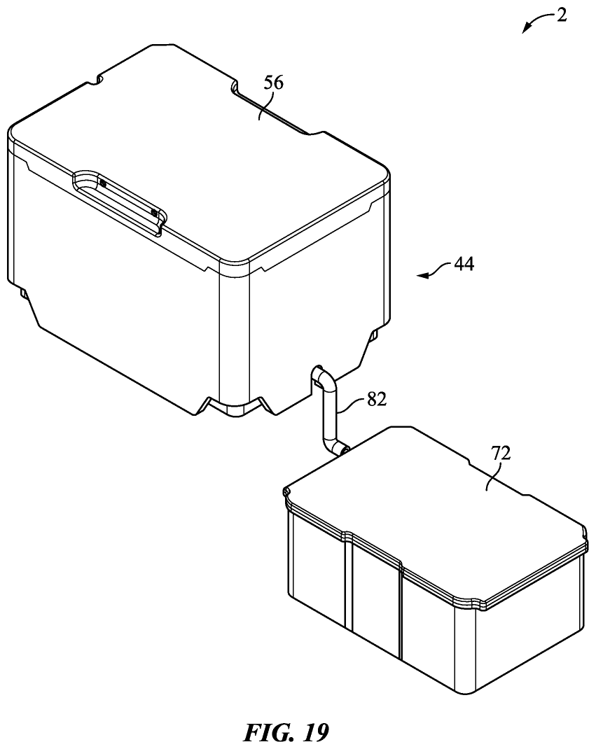

FIG. 19 is a schematic view of another embodiment of the system for histological reactions on histological samples with a thermal cover having a closed top and a waste holding tank. The system 2 includes a thermal control cover 44 having a top 56 to at least partially enclose a container 4 described above. This embodiment further includes a waste holding tank 72 into which used reagents, water, and other fluids can pass from the container through a drain 82.

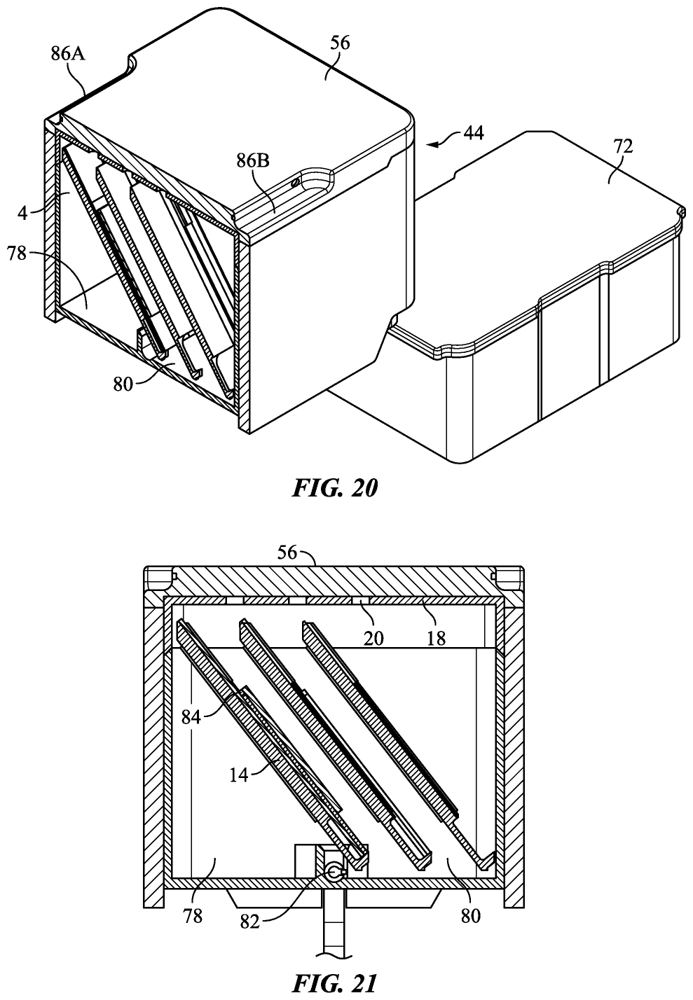

FIG. 20 is a schematic perspective cross sectional view of the system of FIG. 19 illustrating an exemplary arrangement of components with the container for the histological reactions. FIG. 21 is a schematic side cross sectional view of the system of FIG. 20. The container 4 can be at least partially enclosed by the thermal control cover 44 having a top 56, such as around sides of the container, and over the container 4. A lid 18 having lid portals 20 can be positioned under the top 56 and exposed to ambient conditions when the top is removed from the container. The lid portals 20 can provide access to the support tiles 14 with a specimen 84 loaded onto surfaces for histological uses. A bottom portion of the container 4 is divided into two sections: a water compartment 78 for assisting in humidity, and a waste compartment 80 for keeping waste that flows from the histological samples on the support tile or other supports during processing separated from the water in the water compartment. The waste compartment is fluidicly coupled through the drain 82 to the waste holding tank 72

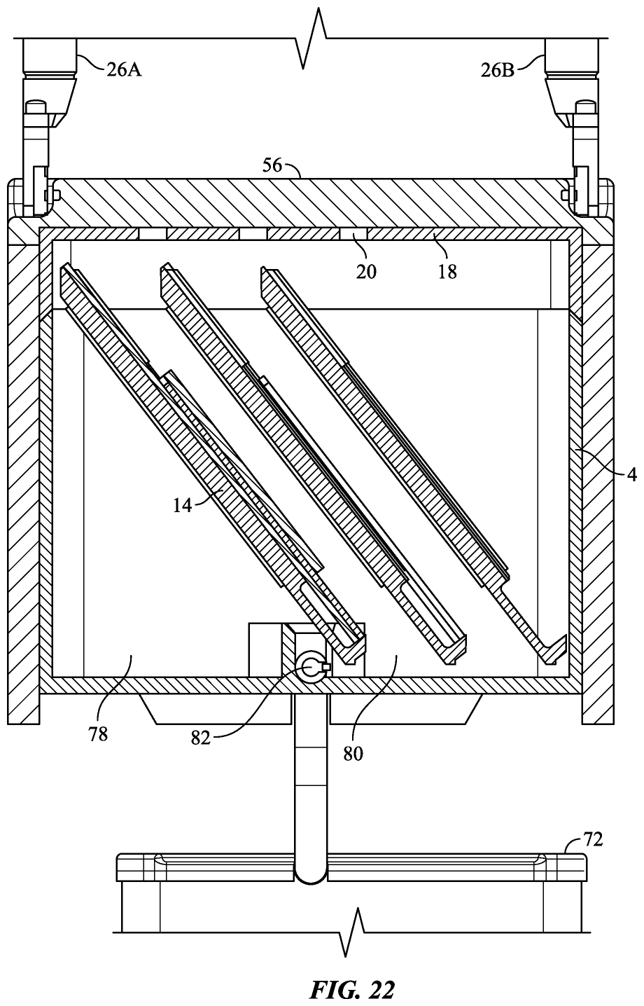

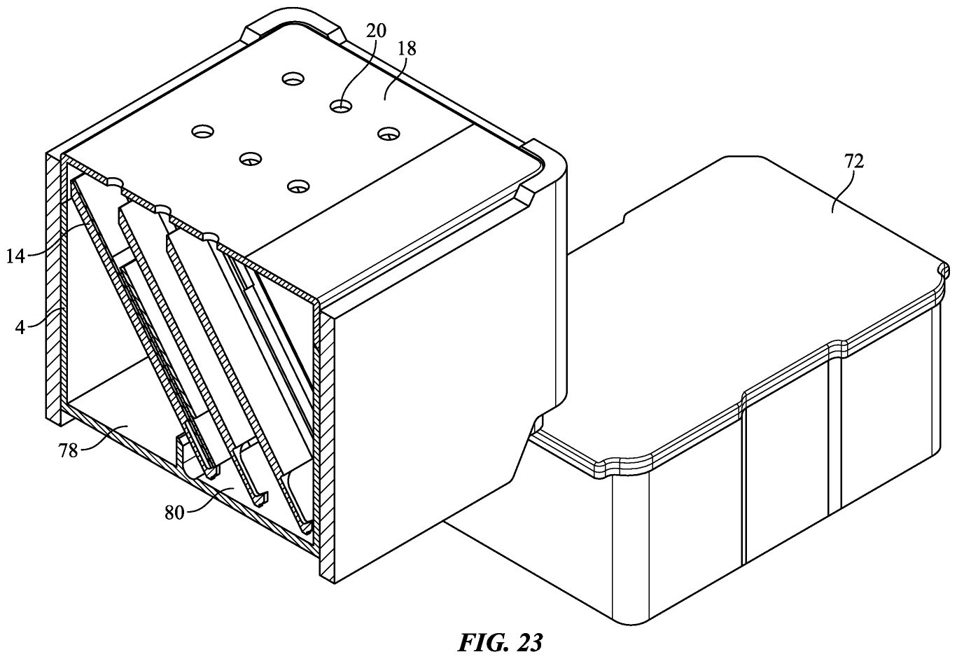

FIG. 22 is a schematic illustration of a robot portion removably coupled to the top of the thermal cover of FIG. 19 to access the lid having lid portals for the histological reactions. FIG. 23 is a schematic perspective cross sectional view of the system of FIG. 20 with the top removed to allow access to the lid and lid portals for the histological reactions. A robot (such as shown in FIGS. 15-18) with robot arms 26A and 26B can engage coupling stations 86A and 86B and lift the top 56 from the container 4 to expose the lid 20 with the lid portals. The histological processing can occur such as described above using a robot and dispensers applying reagents and other substances to specimens supported by the support tile 14 or other support.

Thus, the humidity gradient between the inside of the container and outside of the container can be controlled with the lid and humidifying layer portals. Similarly, the thermal gradient between the inside of the container and outside of the container can be controlled by the shutter or the removable top on the thermal control cover. The thermal control cover can also assist in control of humidity in the container by restricting access of ambient conditions to the inside of the container. The need for a traditional enclosure around the processing center is unnecessary.

Other and further embodiments utilizing one or more aspects of the inventions described above can be devised without departing from the disclosed invention as defined in the claims. For example, other embodiments can include different containers, different shapes and sizes of the cover, different portal locations and arrangement and groupings, different configurations of the shutter and alignment with the cover, and other variations than those specifically disclosed herein within the scope of the claims.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intend to protect fully all such modifications and improvements that come within the scope of the following claims.

What is claimed is:

1. A histological system for preparing histological samples, comprising:
a container configured to support histological samples for at least applying reagents to the histological samples and having an at least partially open top; and
a humidity control lid configured to be coupled with the container and having at least one lid portal configured to be accessed through to an inside of the container, and comprising a humidifying layer having at least one humidifying portal aligned with the lid portal, the humidifying layer configured to create a humidifying zone in the humidifying portal having a humidity greater than the lid portal without the humidifying layer.

2. The histological system of claim 1, further comprising a thermal control cover configured to be placed at least partially around the container with the lid, comprising:
a top having at least one top portal, the top portal being aligned with the lid portal; and
a shutter movably coupled to the top and having at least one shutter portal, wherein the shutter portal is configured to selectively align with the top portal by movement of the shutter relative to the top for selective access through the shutter portal and top portal and through the lid portal into the container.

3. The histological system of claim 2, further comprising a receiver coupled to the shutter and configured to allow a robot to engage the receiver to selectively align the shutter portal with the top portal by movement of the shutter relative to the top.

4. The histological system of claim 2, further comprising a shuttle calibration guide coupled to one of the shuttle and top for positioning the shuttle relative to the top.

5. The histological system of claim 1, further comprising a thermal control cover with a removable top and configured to be placed at least partially over the container with the lid, the top covering the at least one lid portal of the lid, the lid being configured to be removable by a robot.

6. The histological system of claim 1, wherein the container comprises a water compartment and a waste compartment fluidicly separated from the water compartment, the waste compartment aligned under a flow of fluid from the histological samples.

7. The histological system of claim 6, further comprising a waste holding tank and a drain coupled between the waste compartment and the waste holding tank to receive fluid from the waste compartment.

8. A histological system for preparing histological samples, comprising:
a container configured to support histological samples for at least applying reagents to the histological samples and having an at least partially open top;
a lid configured to be coupled with the container and having at least one lid portal configured to be accessed through to an inside of the container; and
a thermal control cover configured to be placed at least partially around the container with the lid, comprising:
a top having at least one top portal, the top portal being aligned with the lid portal; and
a shutter movably coupled to the top and having at least one shutter portal, wherein the shutter portal is configured to selectively align with the top portal by movement of the shutter relative to the top for selectively access through the shutter portal and top portal and through the lid portal into the container.

9. A histological system of claim 8, wherein the lid further comprises a humidifying layer having at least one humidifying portal aligned with the lid portal, the humidifying layer configured to create a humidifying zone in the humidifying portal having a humidity greater than the lid portal without the humidifying layer.

10. A histological system for preparing histological samples, comprising:
a container configured to support histological samples for at least applying reagents to the histological samples and having an at least partially open top;
a humidity control lid configured to be coupled with the container and having at least one lid portal configured to be accessed through to an inside of the container, and comprising a humidifying layer having at least one humidifying portal aligned with the lid portal, the humidifying layer configured to create a humidifying zone in the humidifying portal having a humidity greater than the lid portal without the humidifying layer; and
a thermal control cover with a removable top and configured to be placed at least partially over the container with the humidity control lid, the top covering the at least one lid portal of the lid, the lid being configured to be removable by a robot.

11. The histological system of claim 10, wherein the container comprises a water compartment and a waste compartment fluidicly separated from the water compartment, the waste compartment aligned under a flow of fluid from the histological samples.

12. The histological system of claim 11, further comprising a waste holding tank and a drain coupled between the waste compartment and the waste holding tank to receive fluid from the waste compartment.
